(19) United States
(12) Patent Application Publication
(10) Pub. No.: US 2022/0260536 A1
(43) Pub. Date: Aug. 18, 2022

(54) LIQUID CHROMATOGRAPH

(71) Applicant: SHIMADZU CORPORATION, Kyoto (JP)

(72) Inventor: Satoru Watanabe, Kyoto (JP)

(21) Appl. No.: 17/561,196

(22) Filed: Dec. 23, 2021

(30) Foreign Application Priority Data
Feb. 15, 2021 (JP) 2021-021432

(51) Int. Cl. G01N 30/86; G01N 30/32

(52) U.S. Cl. CPC G01N 30/8631; G01N 2030/326; G01N 30/32

(57) ABSTRACT

A liquid delivery pump (4), an analysis channel (2), an injector (6), a separation column (8), a detector (10), and a controller (12) are provided. Then, the controller (12) includes a setting value storage memory (14) that stores a setting value set by the user for the number of peaks in a chromatogram obtained during analysis started by injection of a sample into the mobile phase by the injector (6), a peak counter (18) configured to count the number of peaks in the chromatogram from start of the analysis, and an end trigger detector (20) configured to detect that the number of peaks from start of the analysis counted by the peak counter (18) reaches the setting value as an end trigger of the analysis being executed, and the controller (12) is configured to end the analysis being executed based on that the end trigger detector (20) detects the end trigger.

### BACKGROUND OF THE INVENTION

### 1. Field of the Invention

The present invention relates to a liquid chromatograph.

### 2. Description of the Related Art

In a liquid chromatograph, an analysis program is often set so as to end analysis when preset analysis time elapses after the analysis starts (see Japanese Patent Laid-open Publication No. 2017-138248). In this case, the user checks how long it takes to perform pre-analysis of a sample and detect a peak of a necessary component, and sets analysis time. In a case where a plurality of samples are continuously analyzed under the same analysis condition, it is necessary to set analysis time according to a sample containing a component having a long retention time in a separation column.

### SUMMARY OF THE INVENTION

In a case where continuous analysis of a plurality of samples is performed by an isocratic method using a mobile phase having a single composition, a compound having a long retention time on a separation column is eluted from the separation column extremely slowly. When analysis time is set according to a sample containing such a compound, analysis of other samples is also performed for a longer time than necessary, and unnecessary analysis data is continuously taken. As a result, there has been a problem that time until analysis on all of a plurality of samples is completed becomes long, and analysis data in a larger amount than necessary is accumulated.

The present invention has been made in view of the above problem, and an object of the present invention is to prevent analysis from being executed for a time longer than necessary.

A liquid chromatograph according to the present invention includes a liquid delivery pump for delivering a mobile phase, an analysis channel through which a mobile phase delivered by the liquid delivery pump flows, an injector for injecting a sample into the mobile phase flowing through the analysis channel, a separation column provided on the analysis channel and for separating components of the sample injected into the mobile phase by the injector, a detector that is provided downstream of the separation column on the analysis channel and detects the components separated in the separation column, and a controller configured to manage operation of the liquid delivery pump and the injector. The controller includes a setting value storage memory that stores a setting value set by a user for the number of peaks in a chromatogram obtained during analysis started by injection of a sample into the mobile phase by the injector, a peak counter configured to count number of peaks in the chromatogram from start of the analysis, and an end trigger detector configured to detect that the number of peaks from start of the analysis counted by the peak counter reaches the setting value as an end trigger of the analysis being executed, and the controller is configured to end the analysis being executed based on that the end trigger detector detects the end trigger.

According to the present invention, the controller is configured to store a set value set by the user for the number of peaks in a chromatogram obtained during analysis, count the number of peaks in the chromatogram after the analysis is started, and detect that the number of peaks reaches a setting value as an end trigger of the analysis during execution, so that the analysis is ended with reference to a time point at which a peak desired by the user is detected. This makes it possible to prevent analysis from being performed for a time longer than necessary.

### BRIEF DESCRIPTION OF THE DRAWINGS

FIG. 1 is a schematic configuration diagram illustrating an embodiment of a liquid chromatograph; and

FIG. 2 is a flowchart illustrating an example of operation of the embodiment.

### DETAILED DESCRIPTION OF THE INVENTION

Hereinafter, an embodiment of a liquid chromatograph according to the present invention will be described with reference to the accompanying drawings.

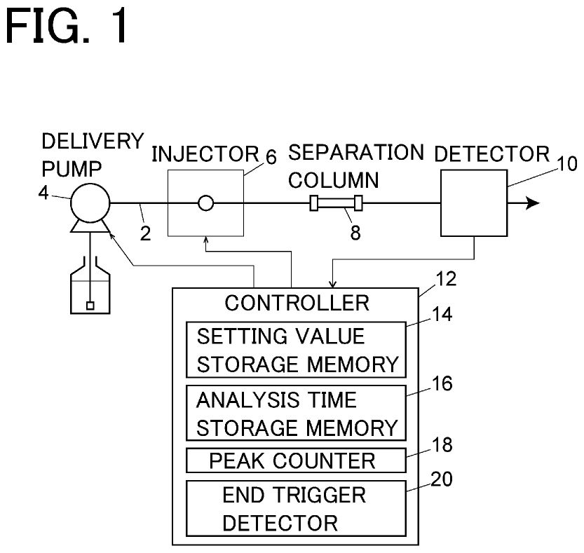

As illustrated in FIG. 1, the liquid chromatograph includes an analysis channel 2, and a mobile phase delivered by a liquid delivery pump 4 flows in the analysis channel 2. An injector 6, a separation column 8, and a detector 10 are provided on the analysis channel 2. The injector 6 injects a sample into a mobile phase flowing through the analysis channel 2. The separation column 8 is provided downstream of the injector 6 on the analysis channel 2 to separate a component of a sample injected into a mobile phase. The detector 10 is provided downstream of the separation column 8 on the analysis channel 2 and is for detecting a component separated in the separation column 8.

Operation of the liquid delivery pump 4 and the injector 6 is managed by a controller 12. The controller 12 is realized by one or more computer devices including a central processing unit (CPU), an information storage device, and the like.

The controller 12 includes a setting value storage memory 14, an analysis time storage memory 16, a peak counter 18, and an end trigger detector 20. The setting value storage memory 14 and the analysis time storage memory 16 are functions implemented by a part of a storage area of the information storage device, and the peak counter 18 and the end trigger detector 20 are functions implemented by execution of a predetermined program by the CPU.

The setting value storage memory 14 stores a setting value by the user for the number of peaks detected on a chromatogram obtained by analysis of a sample. The set value for the number of peaks is for defining an end timing of analysis of a sample. That is, the user can define a timing to end analysis in advance by the number of peaks on a chromatogram. In a case where there is a plurality of samples to be analyzed, the user can set the number of peaks defining an end timing of analysis for each sample. The setting value storage memory 14 stores a setting value for the number of peaks for each sample set by the user.

The analysis time storage memory 16 stores maximum time from the start to the end of one analysis, that is, maximum analysis time. The maximum analysis time may be set by the user or may be specified. Further, in a case where there are a plurality of samples to be analyzed, the maximum analysis time can be set for each sample and stored in the analysis time storage memory 16.

The peak counter 18 is configured to detect a peak on a chromatogram based on a preset peak detection condition after analysis of a sample is started, and count the number of detected peaks. A slope of the chromatogram can be included as the peak detection condition. In this case, a start point of a peak is detected when a slope exceeds a predetermined threshold, and an end point of a peak is detected when a slope falls below a predetermined threshold. Further, a peak level can be included as the peak detection condition. By including a peak level in the peak detection condition, it is possible to cause the peak counter 18 to count only a peak at a certain level or more as a peak.

The end trigger detector 20 is configured to detect that the number of peaks counted by the peak counter 18 from the start of analysis of a sample reaches a set value stored in the setting value storage memory 14 as an end trigger of the analysis being executed.

The controller 12 ends analysis being executed based on the detection of an end trigger by the end trigger detector 20. Further, when elapsed time from the start of analysis exceeds the maximum analysis time stored in the analysis time storage memory 16, the controller 12 ends analysis being executed even if the end trigger detector 20 does not detect an end trigger, and prevents unnecessary analysis data from being continuously collected. Note that operation of ending analysis can include operation of ending collection of analysis data. After analysis ends, the processing can proceed to analysis of a next sample.

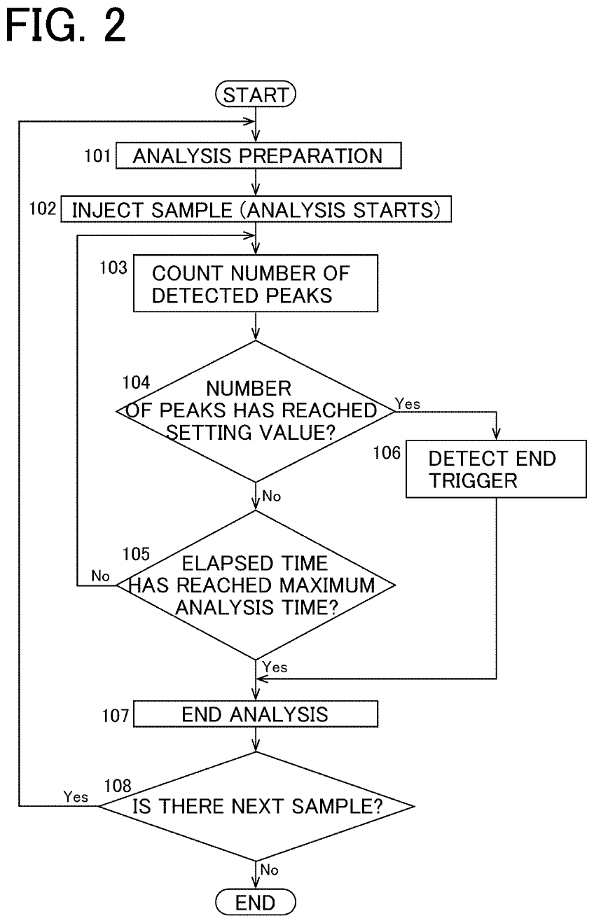

An example of operation of the present embodiment will be described with reference to a flowchart of FIG. 2 together with FIG. 1.

As a premise, the user sets in advance the number of peaks for defining a time of ending analysis for each sample, and a set value of the setting is stored in the setting value storage memory 14. When the user inputs an instruction to start continuous analysis to the controller 12, the controller 12 controls the liquid delivery pump 4 and the injector 6 so that analysis preparation such as adjustment of a flow rate of a mobile phase and collection of a sample to be analyzed is executed (Step 101), and when the analysis preparation is completed, the controller 12 causes the injector 6 to execute sample injection (Step 102). In this manner, analysis of a sample is started.

When analysis of a sample is started, the peak counter 18 of the controller 12 starts counting the number of peaks in a chromatogram obtained based on an output signal from the detector 10 (Step 103). The end trigger detector 20 monitors the number of peaks counted by the peak counter 18 (Step 104). When the number of peaks counted by the peak counter 18 reaches a value set for the sample (Step 104: Yes), the end trigger detector 20 detects an end trigger of the analysis (Step 106). The controller 12 ends the analysis being executed when a predetermined time elapses after the end trigger detector 20 detected the end trigger (Step 107).

Further, the controller 12 measures elapsed time from the start of analysis of the sample. Then, when the elapsed time reaches the maximum analysis time (Step 105: Yes), the analysis being executed is ended even if the end trigger detector 20 does not detect an end trigger (Step 107).

After ending the analysis (Step 107), the controller 12 checks whether or not there is a sample to be analyzed next based on a preset analysis program (Step 108), and in a case where there is a sample to be analyzed next, the controller 12 repeats Steps 101 to 107.

Note that the function of the end trigger detector 20 in the controller 12 may be switched between enabled and disabled as necessary. The switching between enabled and disabled of the function of the end trigger detector 20 may be optionally executed by the user, or the controller 12 may automatically disable the function of the end trigger detector 20 when balancing of a mobile phase is executed or the like.

The embodiment described above is merely an example of an embodiment of the liquid chromatograph according to the present invention, and the embodiment of the liquid chromatograph according to the present invention is as described below.

An embodiment of a liquid chromatograph according to the present invention includes a liquid delivery pump for delivering a mobile phase, an analysis channel through which a mobile phase delivered by the liquid delivery pump flows, an injector for injecting a sample into the mobile phase flowing through the analysis channel, a separation column provided on the analysis channel and for separating components of the sample injected into the mobile phase by the injector, a detector that is provided downstream of the separation column on the analysis channel and detects the components separated in the separation column, and a controller configured to manage operation of the liquid delivery pump and the injector. The controller includes a setting value storage memory that stores a setting value set by a user for the number of peaks in a chromatogram obtained during analysis started by injection of a sample into the mobile phase by the injector, a peak counter configured to count the number of peaks in the chromatogram from star of the analysis, and an end trigger detector configured to detect that the number of peaks from start of the analysis counted by the peak counter reaches the setting value as an end trigger of the analysis being executed, and the controller is configured to end the analysis being executed based on that the end trigger detector detects the end trigger.

In a first aspect of the above embodiment, the controller is configured to end the analysis being executed when a predetermined time elapses after the end trigger detector detects the end trigger.

In a second aspect of the above embodiment, the controller further includes an analysis time storage memory that stores a maximum analysis time that has been set previously, and the controller is configured to end the analysis if an elapsed time from start of the analysis reaches the maximum analysis time before the end trigger detector detects the end trigger. According to such an aspect, it is possible to prevent a situation in which analysis becomes long due to a compound extremely slowly eluted and unnecessary data collection is continued. This second aspect can be combined with the first aspect.

In the second aspect, the controller may be configured to sequentially execute analysis on a plurality of samples based on an analysis program that has been set previously, and the analysis time storage memory may store the maximum analysis time for each of a plurality of the samples.

In a third aspect of the above embodiment, the controller is configured to sequentially execute analysis on a plurality of samples based on an analysis program that has been set previously, the setting value storage memory stores the setting value for each of a plurality of the samples, and the end trigger detector is configured to detect the end trigger by using the set value for each sample in analysis of each of a plurality of the samples. According to such an aspect, it is possible to define an end timing of analysis corresponding to each of a plurality of samples. This third aspect can be combined with the first aspect and/or the second aspect described above.

Ina fourth aspect of the above embodiment, the controller is configured to switch between enabling and disabling of the end trigger detector based on an instruction from a user and/or automatically. According to such an aspect, setting of an end timing of analysis based on the number of peaks can be disabled as necessary, and an end timing of analysis can be flexibly set in such a manner that, for example, an end timing of analysis is defined only based on elapsed time from start of the analysis. This fourth aspect can be combined with the first aspect, the second aspect, and/or the third aspect described above.

### DESCRIPTION OF REFERENCE SIGNS

2 analysis channel
4 liquid delivery pump
6 injector
8 separation column
10 detector
12 controller
14 setting value storage memory
16 analysis time storage memory
18 peak counter
20 end trigger detector

What is claimed is:

1. A liquid chromatograph comprising:
a liquid delivery pump for delivering a mobile phase;
an analysis channel through which a mobile phase delivered by the liquid delivery pump flows;
an injector for injecting a sample into the mobile phase flowing through the analysis channel;
a separation column provided on the analysis channel and for separating components of the sample injected into the mobile phase by the injector;
a detector that is provided downstream of the separation column on the analysis channel and detects the components separated in the separation column; and
a controller configured to manage operation of the liquid delivery pump and the injector,
wherein the controller includes:
a setting value storage memory that stores a setting value set by a user for number of peaks in a chromatogram obtained during analysis started by injection of a sample into the mobile phase by the injector;
a peak counter configured to count number of peaks in the chromatogram from start of the analysis; and
an end trigger detector configured to detect that number of peaks from start of the analysis counted by the peak counter reaches the setting value as an end trigger of the analysis being executed, and
the controller is configured to end the analysis being executed based on that the end trigger detector detects the end trigger.

2. The liquid chromatograph according to claim 1, wherein the controller is configured to end the analysis being executed when a predetermined time elapses after the end trigger detector detects the end trigger.

3. The liquid chromatograph according to claim 1, wherein the controller further includes an analysis time storage memory that stores a maximum analysis time that has been set previously, and the controller is configured to end the analysis if an elapsed time from start of the analysis reaches the maximum analysis time before the end trigger detector detects the end trigger.

4. The liquid chromatograph according to claim 1, wherein
the controller is configured to sequentially execute analysis on a plurality of samples based on an analysis program that has been set previously, and
the analysis time storage memory stores the maximum analysis time for each of the plurality of samples.

5. The liquid chromatograph according to claim 1, wherein
the controller is configured to sequentially execute analysis on a plurality of samples based on an analysis program that has been set previously,
the setting value storage memory stores the setting value for each of the plurality of samples, and
the end trigger detector is configured to detect the end trigger by using the set value for each sample in analysis of each of the plurality of samples.

6. The liquid chromatograph of claim 1, wherein the controller is configured to switch between enabling and disabling of the end trigger detector based on an instruction from a user and/or automatically.
